(19) United States
(12) Patent Application Publication
(10) Pub. No.: US 2026/0278263 A1
(43) Pub. Date: Sep. 17, 2026

(54) DOCUMENT GENERATION SYSTEM, DOCUMENT GENERATION METHOD, AND RECORDING MEDIUM

(71) Applicant: NEC Corporation, Tokyo (JP)

(72) Inventor: Shinya KAMADA, Tokyo (JP)

(73) Assignee: NEC Corporation, Tokyo (JP)

(21) Appl. No.: 19/555,000

(22) Filed: Mar. 3, 2026

(30) Foreign Application Priority Data
Mar. 14, 2025 (JP) 2025-041784

(51) Int. Cl. G06F 40/186

(52) U.S. Cl. CPC G06F 40/186

(57) ABSTRACT

A document generation system includes a document generation unit for inputting, to a large language model, a template of a document and an input document that is an individual document for each document generated by the large language model to generate an output document, a template correction unit for inputting the output document, a final document that is a document obtained by a user correcting the output document, the template, and the input document to a large language model to generate a corrected template, and a template providing unit for storing a plurality of templates including the corrected template, and outputting a selected template among the plurality of stored templates to the document generation unit.

This application is based upon and claims the benefit of priority from Japanese Patent Application No. 2025-041784 filed on Mar. 14, 2025, the disclosure of which is incorporated herein in its entirety by reference.

### TECHNICAL FIELD

The present disclosure relates to a document generation system, a document generation method, and a recording medium.

### BACKGROUND ART

A document may be generated using a large language model (see, for example, JP 7526415 B2).

### SUMMARY

In a case where the same type of document is repeatedly generated using the large language model, it is conceivable to perform adjustment in such a way as to obtain a document desired by the user or a document close to the document. In this case, the burden on the user is preferably as small as possible.

An example object of the present disclosure is to provide a document generation system, a document generation method, and a recording medium that can solve the above-described problems.

According to a first aspect of the present disclosure, a document generation system includes a document generation means for inputting, to a large language model, a template of a document and an input document that is an individual document for each document generated by the large language model to generate an output document, a template correction means for inputting the output document, a final document that is a document obtained by a user correcting the output document, the template, and the input document to a large language model to generate a corrected template, and a template providing means for storing a plurality of templates including the corrected template, and outputting a selected template among the plurality of stored templates to the document generation means.

According to a second aspect of the present disclosure, a document generation method executed by a computer includes inputting, to a large language model, a template of a document and an input document that is an individual document for each document generated by the large language model to generate an output document, inputting the output document, a final document that is a document obtained by a user correcting the output document, the template, and the input document to a large language model to generate a corrected template, and storing a plurality of templates including the corrected template, and using a selected template among the plurality of stored templates in generating the output document.

According to a third aspect of the present disclosure, a program causes a computer to execute the steps of inputting, to a large language model, a template of a document and an input document that is an individual document for each document generated by the large language model to generate an output document, inputting the output document, a final document that is a document obtained by a user correcting the output document, the template, and the input document to a large language model to generate a corrected template, and storing a plurality of templates including the corrected template, and using a selected template among the plurality of stored templates in generating the output document.

### BRIEF DESCRIPTION OF THE DRAWINGS

Exemplary features and advantages of the present disclosure will become apparent from the following detailed description upon being taken with the accompanying drawings in which:

FIG. 1 is a diagram illustrating an example of a configuration of a document generation system according to at least one example embodiment;

FIG. 2 is a diagram illustrating an example of input/output of data in each unit of the document generation system according to at least one example embodiment;

FIG. 3 is a diagram illustrating an example of an input document in at least one example embodiment;

FIG. 4 is a diagram illustrating an example of a template in at least one example embodiment;

FIG. 5 is a diagram illustrating an example of an output document in at least one example embodiment;

FIG. 6 is a diagram illustrating an example of a final document in at least one example embodiment;

FIG. 7 is a diagram illustrating an example of an instruction input to a large language model by a template correction unit according to at least one example embodiment;

FIG. 8 is a diagram illustrating an example of a template after correction in at least one example embodiment;

FIG. 9 is a diagram illustrating an example of input/output of data in each unit of the document generation system according to at least one example embodiment;

FIG. 10 is a diagram illustrating an example of input/output of data in a case where the number of templates stored in a template providing unit according to at least one example embodiment is reduced;

FIG. 11 is a diagram illustrating an example of a configuration of a document generation system according to at least one example embodiment;

FIG. 12 is a diagram illustrating an example of a procedure of processing in the document generation method according to at least one example embodiment; and

FIG. 13 is a diagram illustrating an example of a configuration of a computer according to at least one example embodiment.

### EXAMPLE EMBODIMENT

Hereinafter, example embodiments will be described with reference to the drawings.

### First Example Embodiment

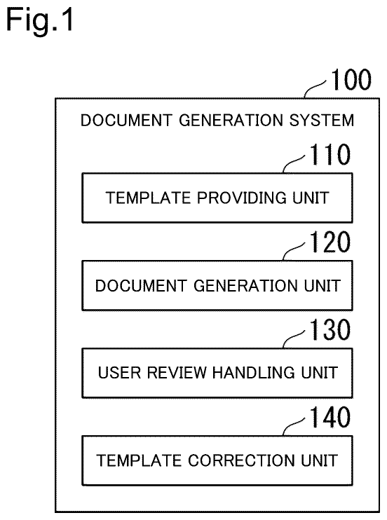

FIG. 1 is a diagram illustrating an example of a configuration of a document generation system according to at least one example embodiment. With the configuration illustrated in FIG. 1, a document generation system 100 includes a template providing unit 110, a document generation unit 120, a user review handling unit 130, and a template correction unit 140.

The document generation system 100 generates a document using a large language model (LLM). Specifically, the document generation system 100 generates a document by inputting a template of the document and an input document generated by the user to a large language model. The document generation system 100 corrects the template based on the user's correction to the generated document in such a way that the document before correction approaches the document after correction.

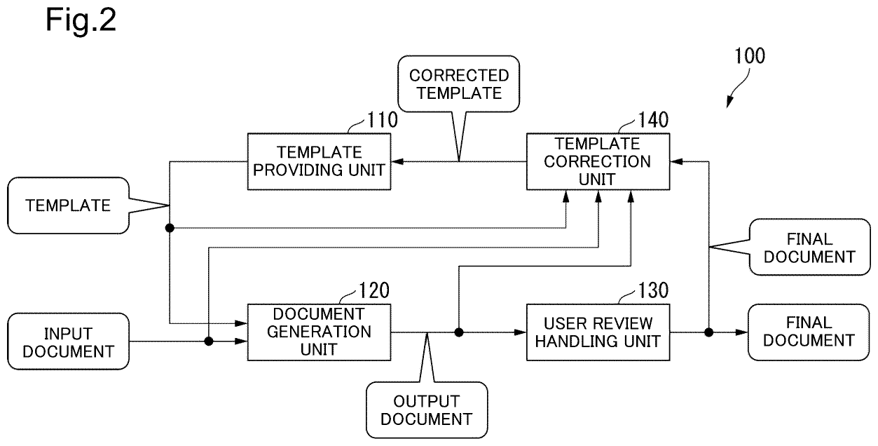

FIG. 2 is a diagram illustrating an example of input/output of data in each unit of the document generation system 100.

The template providing unit 110 provides a template for document generation. For example, the template providing unit 110 stores a plurality of templates. In response to the user selects any one of the templates stored in the template providing unit 110, the template providing unit 110 outputs the selected template to the document generation unit 120.

The template providing unit 110 corresponds to an example of a template providing means.

The document generation unit 120 receives the input of the template and the input document to generate and output the document. The input document is a document based on which the user wants to generate a document. The user generates and inputs an input document to the document generation unit 120, and selects a template stored in the template providing unit 110 and inputs the selected template to the document generation unit 120.

The document generation unit 120 corresponds to an example of a document generation means.

The document output by the document generation unit 120 is referred to as an output document. The document generation unit 120 is configured to include a large language model, and inputs a template and an input document to the large language model to generate an output document.

The user review handling unit 130 receives correction of the output document by the user. The user review handling unit 130 may display the output document and receive a correction operation by the user. Alternatively, the user review handling unit 130 may receive the input of the output document corrected by the user.

The output document corrected by the user is referred to as a final document. The user review handling unit 130 outputs the final document to the template correction unit. The user review handling unit 130 provides the final document to the user.

The template correction unit 140 corrects the template. The template correction unit 140 corresponds to an example of a template correction means.

Specifically, the template correction unit 140 acquires a template, an input document, an output document, and a final document. For example, the document generation unit 120 may output a template, an input document, and an output document to the template correction unit 140. As described above, the user review handling unit 130 may output the final document to the template correction unit 140.

The template correction unit 140 corrects the template so that the output document generated based on the template and the input document by the document generation unit 120 approaches the final document that is the document after the correction by the user. The template correction unit 140 includes a large language model, and inputs a template, an input document, an output document, and a final document to the large language model to generate a corrected template.

The large language model used by the document generation unit 120 and the large language model used by the template correction unit 140 may be the same. That is, the document generation unit 120 and the template correction unit 140 may share one large language model. Alternatively, the document generation unit 120 and the template correction unit 140 may use different large language models.

The template correction unit 140 outputs the corrected template to the template providing unit 110. The template providing unit 110 stores the corrected template. The template providing unit 110 may delete the template before correction and replace it with the template after correction. Alternatively, the template providing unit 110 may newly add a template after correction while leaving a template before correction.

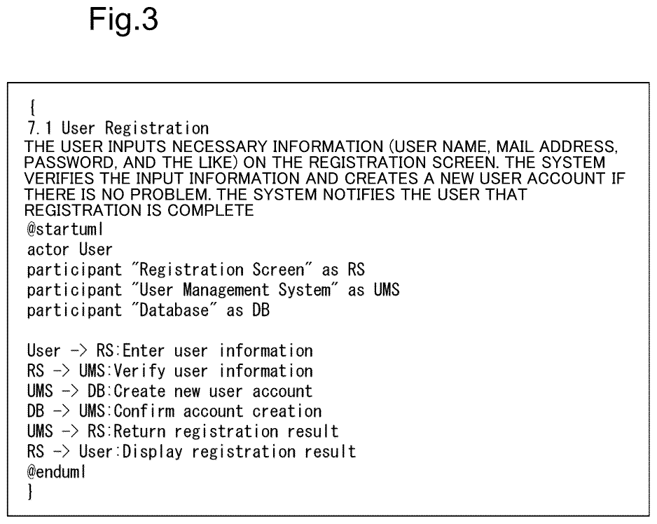

FIG. 3 is a diagram illustrating an example of an input document.

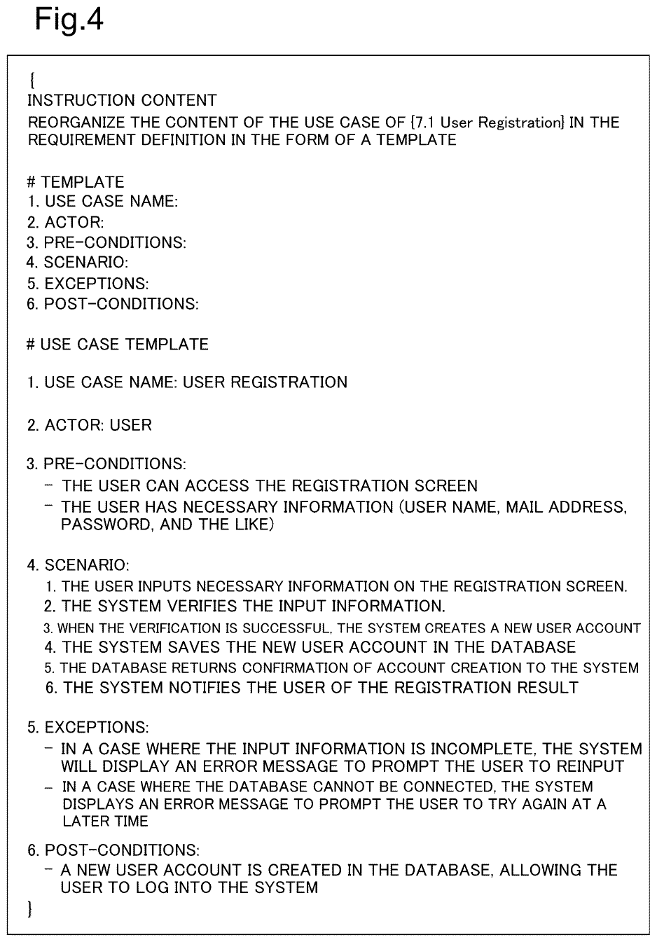

FIG. 4 is a diagram illustrating an example of a template.

The template in the example of FIG. 4 includes an instruction “Reorganize the content of the use case of {7.1 User Registration} of the requirement definition in the form of a template” and a body of the template. According to this instruction, the large language model of the document generation unit 120 generates an output document in which the input document of FIG. 3 is summarized in the form of the template body of FIG. 4.

The “use case template” in FIG. 4 shows an example of an output document using this template to a large language model.

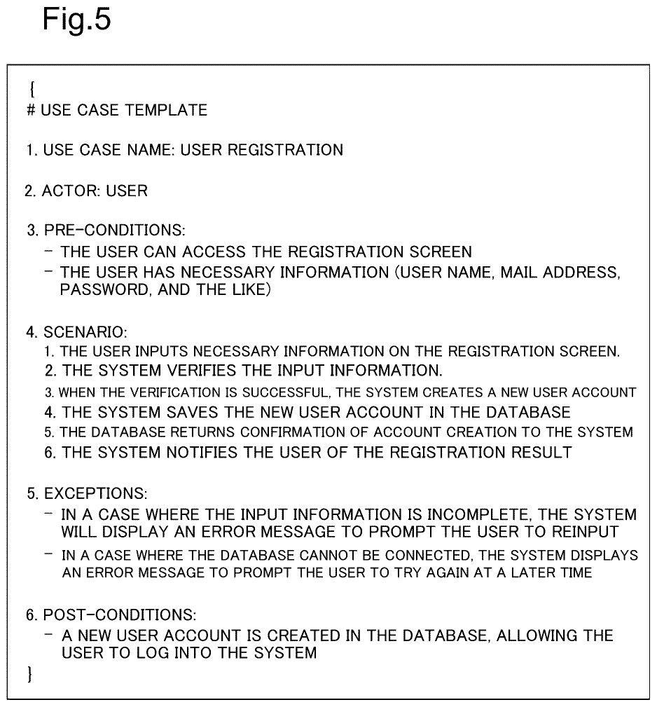

FIG. 5 is a diagram illustrating an example of an output document. FIG. 5 illustrates an example of a case where the large language model generates the output document based on the input document illustrated in FIG. 3 and the template illustrated in FIG. 4.

In the example of FIG. 5, the document generation unit 120 generates an output document in which the content of the input document illustrated in FIG. 3 is summarized in the form of the template illustrated in FIG. 4.

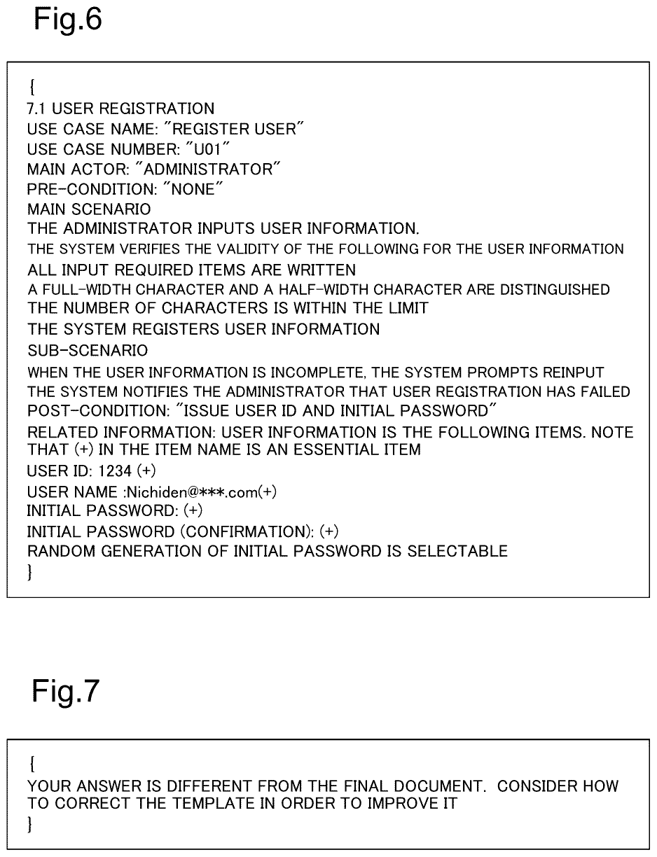

FIG. 6 is a diagram illustrating an example of a final document. FIG. 6 illustrates an example in which the user has modified the final document illustrated in FIG. 5.

FIG. 7 is a diagram illustrating an example of an instruction input to the large language model by the template correction unit 140.

In the example of FIG. 7, the template correction unit 140 outputs a sentence “Your answer is different from the final document. Consider how to correct the template in order to improve it” to a large language model.

Thereby, it is expected that the large language model will generate a template with the output document (“your answer”) corrected to approach the final document.

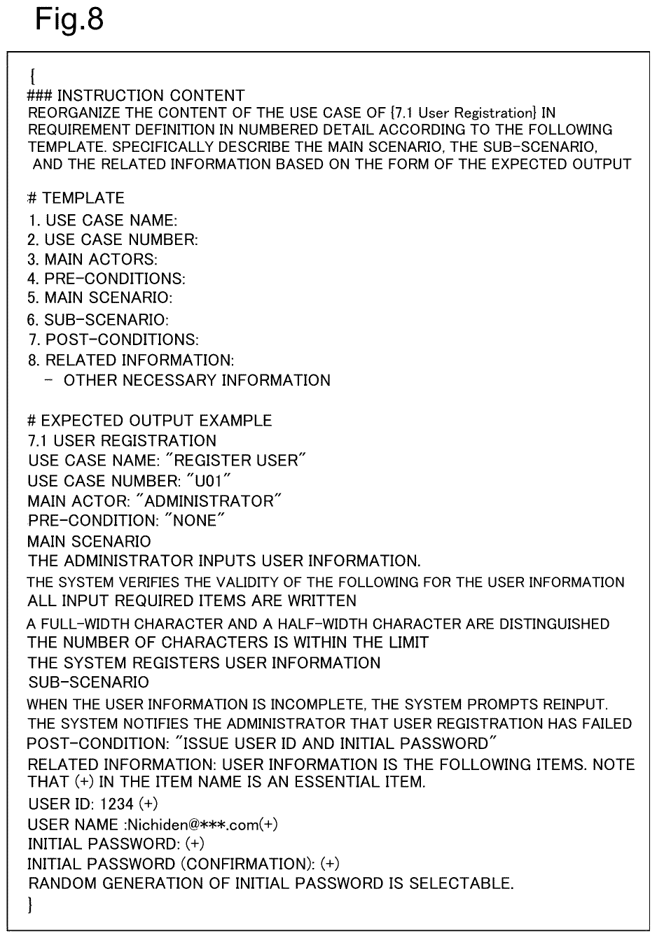

FIG. 8 is a diagram illustrating an example of a template after correction. FIG. 8 illustrates an example in which the large language model of the template correction unit 140 generates the corrected template according to the instruction illustrated in FIG. 7 based on the input document illustrated in FIG. 3, the template illustrated in FIG. 4, the output document illustrated in FIG. 5, and the output document illustrated in FIG. 6.

In the example of FIG. 8, the large language model of the template correction unit 140 corrects the template to match the form of the final document illustrated in FIG. 6.

In this manner, the template correction unit 140 automatically generates a corrected template based on the template, the input document, the output document, and the final document. As a result, the user is only required to correct the output document to the final document, and does not need to perform additional work to correct the template. According to the document generation system 100, in this respect, it is possible to

### Reduce the Burden on the User in Correcting the Template.

The correction of the template (generation of the corrected template) by the template correction unit 140 corresponds to an example of adjustment to the generation of the output document by the large language model. This adjustment can also be referred to as fine-tuning for the generation of the output document by the large language model.

As described above, the document generation unit 120 generates the output document by inputting the template of the document and the input document that is an individual document for each document generated by the large language model to the large language model.

The template correction unit 140 inputs the output document, the final document which is a document obtained by correcting the output document by the user, the template, and the input document to the large language model to generate a corrected template.

The template providing unit 110 stores a plurality of templates including a corrected template, and outputs a selected template among the plurality of stored templates to the document generation unit 120.

According to the document generation system 100, the template of the document and the input document are input to the large language model to generate the output document, and the template, the input document, the output document, and the correction document are input to the large language model to generate the corrected template, so that the adjustment with respect to the generation of the output document by the large language model can be automated.

As a result, in the document generation system 100, the user is only required to correct the output document to the final document, and does not need to perform a separate operation to correct the template. According to the document generation system 100, in this respect, in a case where the same type of document is repeatedly generated using the large language model, a burden on the user for adjustment for obtaining the document desired by the user is relatively small.

According to an aspect of the present disclosure, in a case where the same type of document is repeatedly generated by using a large language model, a burden on a user for adjustment for obtaining a document desired by the user or a document close to the document is relatively small.

### Second Example Embodiment

The template providing unit may output a plurality of templates to the document generation unit.

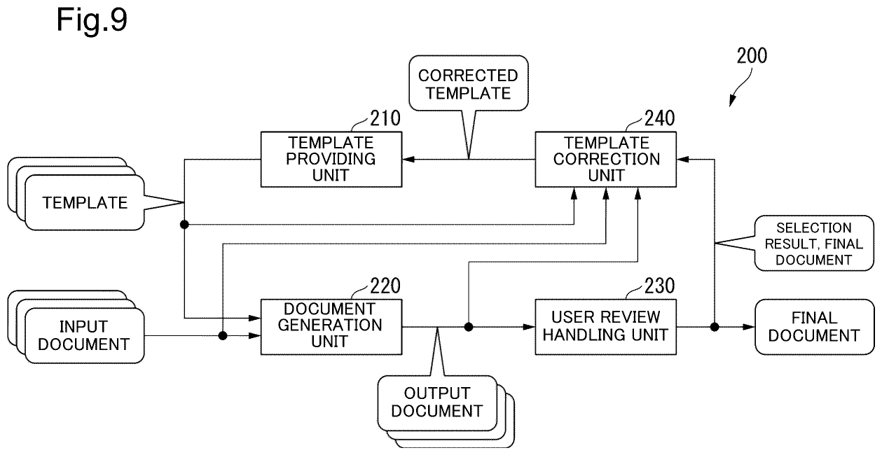

FIG. 9 is a diagram illustrating an example of input/output of data in each unit of a document generation system 200.

The document generation system 200 corresponds to an example of the document generation system 100.

In the example of FIG. 9, the document generation system 200 includes a template providing unit 210, a document generation unit 220, a user review handling unit 230, and a template correction unit 240.

The template providing unit 210 stores a plurality of templates. The template providing unit 210 selects a plurality of templates from the stored templates and outputs the selected templates to the document generation unit 220. The template providing unit 210 corresponds to an example of a template providing means.

A method of selecting a template by the template providing unit 210 is not limited to a specific method.

For example, the template providing unit 210 may select a template having a high use frequency and some new templates based on the number of times of use of the template. For example, the template providing unit 210 may select a predetermined number of templates in descending order of the number of times of use of the template, and may select a template that has not been selected by the template providing unit 210 even once after being generated, or a template that has been selected by the template providing unit 210 a predetermined number of times or less.

As the use frequency of the template, the number of times the user selects the output document generated using the template can be used.

Regarding the number of times of use of the template, the template providing unit 210 may generate a tree diagram based on generation of the template and calculate the number of times of use of the template based on the tree diagram. For example, in a case where a certain template is used, the template providing unit 210 may add a value obtained by multiplying the number of times of use of another template by a coefficient that is larger as the distance on the tree diagram is shorter.

The user generates an input document for each selected template and inputs the input document to the document generation unit 220. In a case where one input document can be shared by a plurality of templates, the user may copy the input document for each template and input the copied input document to the document generation unit 220. Alternatively, the user may instruct the document generation unit 220 on the correspondence between the template and the input document, and the document generation unit 220 may copy the input document.

For each input template, the document generation unit 220 inputs the template and the input document input in association with the template to the large language model to generate an output document. The process of generating individual output documents by the document generation unit 220 is similar to that described for the document generation unit 120 with reference to FIG. 2.

The document generation unit 220 outputs the output document in an aspect in which the template, the input document, and the output document are recognized, for example, by assigning common identification numbers to the template, the input document, and the output document.

The document generation unit 220 corresponds to an example of a document generation means.

The user review handling unit 230 receives selection of the output document by the user and correction of the selected output document by the user. For example, the user review handling unit 230 may display a plurality of output documents generated by the document generation unit 220 and receive an operation by the user to select one output document. The user review handling unit 230 may receive a user's correction operation for the selected output document.

The user review handling unit 230 outputs information indicating a selection result of the output document by the user and a final document obtained by the user correcting the selected output document to the template correction unit 240.

The user review handling unit 230 also outputs information indicating a selection result of the output document by the user to the template providing unit 210. This information is used by the template providing unit 210 to calculate the number of times of use of each template.

The user review handling unit 230 provides the final document to the user.

The template correction unit 240 corrects the template based on the template, the input document, the output document, the selection result of the output document by the user, and the final document. For example, the template correction unit 240 may input the selected output document, the template and the input document used to generate the output document, and the final document to the large language model, and generate the corrected template as in the description of the template correction unit 140.

The template correction unit 240 corresponds to an example of a template correction means.

The template providing unit 210 stores the corrected template as in the description of the template providing unit 110 with reference to FIG. 2.

As described above, the template providing unit 210 selects a template, so that the user can use the document generation system 200 without having to grasp the template stored in the template providing unit 210.

The template providing unit 210 selects a plurality of templates, and the document generation unit 220 generates a document for each of the selected templates, so that it is expected that a document desired by the user or a document close to the document can be easily obtained.

In a case where the number of templates stored in the template providing unit 210 increases, the document generation system 200 may reduce the number of templates.

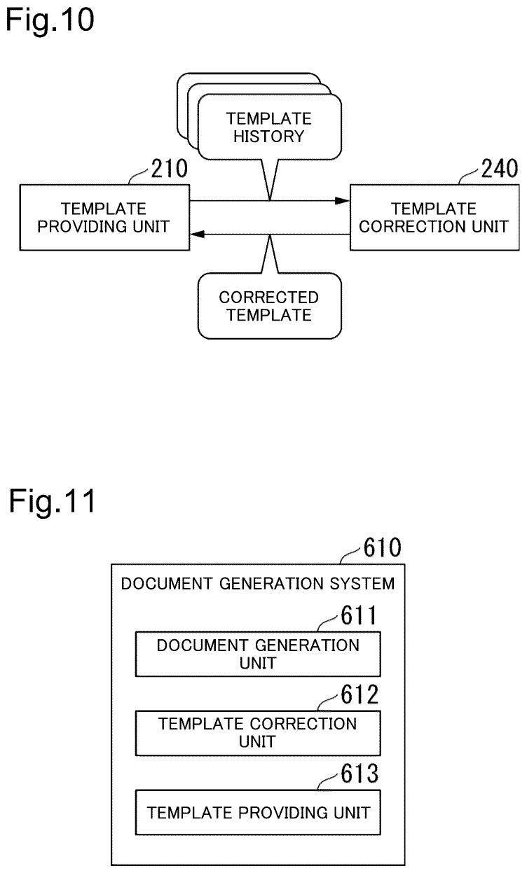

FIG. 10 is a diagram illustrating an example of input/output of data in a case where the number of templates stored in the template providing unit 210 is reduced.

The number of templates may be reduced in a case where the number of templates stored in the template providing unit 210 increases to a predetermined number or more, for example, 5 or more.

In the example of FIG. 10, the template providing unit 210 selects a plurality of templates among a plurality of templates stored in the template providing unit 210, and outputs the selected templates to the template correction unit 240.

A method of selecting a template by the template providing unit 210 is not limited to a specific method.

For example, the template providing unit 210 may select a template having a high use frequency based on the number of times of use of the template. Further, for example, the template providing unit 210 may select a predetermined number of templates in descending order of the number of times of use of the template.

As the use frequency of the template, the number of times the user selects the output document generated using the template can be used.

Alternatively, the template providing unit 210 may select a template with a low use frequency. Further, for example, the template providing unit 210 may select a predetermined number of templates in ascending order of the number of times of use of the templates.

Regarding the number of times of use of the template, the template providing unit 210 may generate a tree diagram based on generation of the template and calculate the number of times of use of the template based on the tree diagram. For example, in a case where a certain template is used, the template providing unit 210 may add a value obtained by multiplying the number of times of use of another template by a coefficient that is 0 or more and 1 or less, the coefficient being larger as the distance on the tree diagram is shorter.

The template correction unit 240 generates a template in which a plurality of templates output from the template providing unit 210 is combined into one template as a corrected template, and outputs the template to the template providing unit 210.

The template providing unit 210 replaces the selected template (template output to the template correction unit 240) with the corrected template. That is, the template providing unit 210 deletes the selected template among the templates stored in the template providing unit 210. The template providing unit 210 stores the corrected template.

The template correction unit 240 may merge the plurality of templates output from the template providing unit 210 into one template. For example, the template correction unit 240 may generate a new template having all the items appearing in one or more templates as a corrected template. The template correction unit 240 may input the plurality of templates output from the template providing unit 210 to the large language model to generate a new template.

As described above, the template providing unit 210 replaces a plurality of templates among the templates stored in the template providing unit 210 with a corrected template obtained by combining the plurality of templates, and thus, it is expected that the possibility that the document generation system 200 can generate a document desired by the user or a document close to the document is increased.

In a case where the template correction unit 240 combines a plurality of templates having a large number of times of use among the templates stored in the template providing unit 210 into one, it is expected that a template with which a document desired by the user or a document close to the document can be obtained can be obtained.

In a case where the template correction unit 240 combines a plurality of templates having a small number of times of use among the templates stored in the template providing unit 210 into one, it is expected that the number of templates stored in the template providing unit 210 is reduced, and in a case where the document generation system 200 generates a document, it is expected that the possibility that a template with which a document desired by the user or a document close to the document can be obtained is selected is increased.

As described above, the template providing unit 210 outputs the plurality of selected templates among the plurality of stored templates to the document generation unit 220.

The document generation unit 220 generates an output document for each of the plurality of selected templates.

The template correction unit 240 inputs an output document selected by the user among the plurality of generated output documents, a final document obtained by the user correcting the output document, and a template and an input document based on which the output document is generated to the large language model, and acquires a corrected template for the template.

In the document generation system 200, the template providing unit 210 selects a template, so that the user can use the document generation system 200 without having to grasp the template stored in the template providing unit 210.

In the document generation system 200, the template providing unit 210 selects a plurality of templates, and the document generation unit 220 generates a document for each of the selected templates, so that it is expected that an output document desired by the user or an output document close to the output document can be easily obtained.

The template providing unit 210 selects a plurality of templates to be output to the document generation unit 220 based on the number of times the template has been used to generate the output document selected by the user.

According to the document generation system 200, it is possible to select a template that has been used for generating the output document selected by the user a relatively large number of times, which is expected to make it easier to obtain the output document desired by the user or an output document close to the output document.

In a case where a certain template is used to generate an output document selected by the user, the template providing unit 210, for each template stored in the template providing means, adds a value obtained by multiplying the number of times of use of the template by a coefficient that is 0 or more and 1 or less, the coefficient being larger as a distance between the template and a template used to generate an output document selected by the user on a tree diagram based on generation of the template is shorter.

According to the document generation system 200, the number of times of use of each template can be calculated in consideration of not only the number of times each template is used to generate the output document selected by the user but also the similarity with the template used to generate the output document selected by the user. According to the document generation system 200, by selecting a template based on the number of times of use, it is expected that an output document desired by the user or an output document close to the output document can be easily obtained.

In a case where the number of templates stored in the template providing unit 210 is greater than or equal to a predetermined number, the template correction unit 240 generates a corrected template in which a plurality of selected templates among the templates stored in the template providing unit 210 is combined into one template.

The template providing unit 210 replaces a plurality of selected templates among the templates stored in the template providing unit 210 with a corrected template in which the plurality of templates is combined into one template.

As a result, in the document generation system 200, it is expected that the possibility that the document generation system 200 can generate a document desired by the user or a document close to the document is increased.

The template correction unit 240 generates a corrected template in which a plurality of templates selected in descending order of the number of times of use in generating the output document selected by the user among the templates stored in the template providing unit 210 is combined into one template.

In the document generation system 200, the template correction unit 240 combines a plurality of templates having a large number of times of use among the templates stored in the template providing unit 210 into one, so that it is expected that a template with which a document desired by the user or a document close to the document can be obtained can be obtained.

The template correction unit 240 generates a corrected template in which a plurality of templates selected in ascending order of the number of times of use in generation of the output document selected by the user among the templates stored in the template providing unit 210 is combined into one template.

As a result, the number of templates stored in the template providing unit 210 is reduced, and in a case where the document generation system 200 generates a document, it is expected that a possibility that a template with which a document desired by the user or a document close to the document can be obtained is selected is increased.

### Third Example Embodiment

FIG. 11 is a diagram illustrating an example of a configuration of a document generation system according to at least one example embodiment. In the configuration illustrated in FIG. 11, a document generation system 610 includes a document generation unit 611, a template correction unit 612, and a template providing unit 613.

With this configuration, the document generation unit 611 generates an output document by inputting, to the large language model, the template of the document and an input document that is an individual document for each document generated by the large language model.

The template correction unit 612 inputs the output document, the final document which is a document obtained by correcting the output document by the user, the template, and the input document to the large language model to generate a corrected template.

The template providing unit 613 stores a plurality of templates including a corrected template, and outputs a selected template among the plurality of stored templates to the document generation unit 611.

The document generation unit 611 corresponds to an example of a document generation means. The template correction unit 612 corresponds to an example of a template correction means. The template providing unit 613 corresponds to an example of a template providing means.

According to the document generation system 610, the template of the document and the input document are input to the large language model to generate the output document, and the template, the input document, the output document, and the correction document are input to the large language model to generate the corrected template, so that the adjustment with respect to the generation of the output document by the large language model can be automated.

As a result, in the document generation system 610, the user is only required to correct the output document to the final document, and does not need to perform a separate operation to correct the template. According to the document generation system 610, in this respect, in a case where the same type of document is repeatedly generated using the large language model, a burden on the user for adjustment for obtaining the document desired by the user is relatively small.

### Fourth Example Embodiment

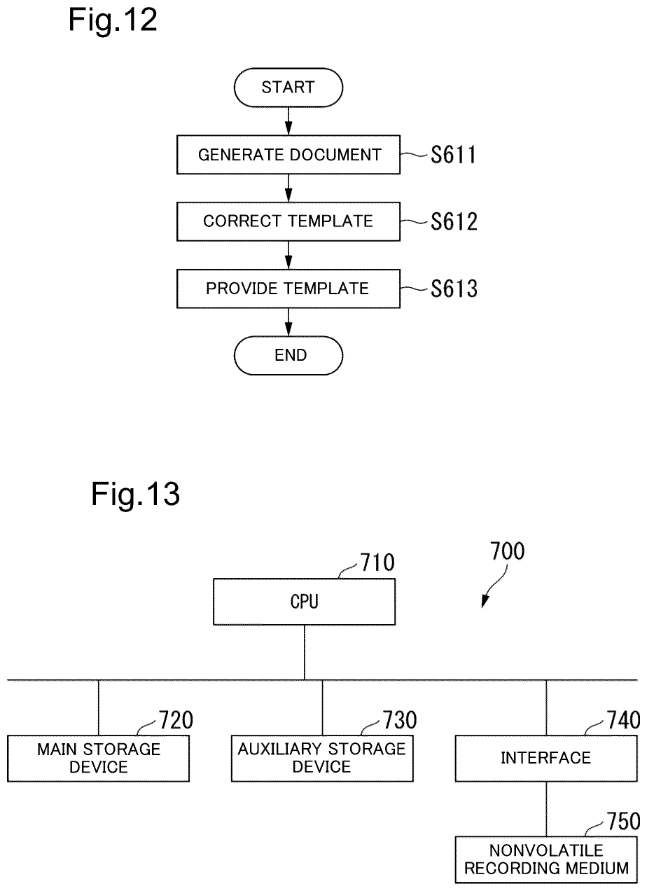

FIG. 12 is a diagram illustrating an example of a procedure of processing in the document generation method according to at least one example embodiment. The document generation method illustrated in FIG. 12 includes generating a document (step S621), correcting a template (step S622), and providing a template (step S623).

In generating the document (step S621), the computer inputs a template of the document and an input document, which is an individual document for each document generated by the large language model, into the large language model to generate an output document.

In correcting the template (step S622), the computer inputs the output document, the final document that is a document obtained by correcting the output document by the user, the template, and the input document into the large language model to generate a corrected template.

In providing the template (step S623), the computer stores a plurality of templates including the corrected template, and uses a selected template among the plurality of stored templates in generating the output document.

According to the document generation method illustrated in FIG. 12, the template of the document and the input document are input to the large language model to generate the output document, and the template, the input document, the output document, and the correction document are input to the large language model to generate the corrected template, so that the adjustment with respect to the generation of the output document by the large language model can be automated.

As a result, in the document generation method illustrated in FIG. 12, the user is only required to correct the output document to the final document, and does not need to perform a separate operation to correct the template. According to the document generation method illustrated in FIG. 12, in this regard, in a case where the same type of document is repeatedly generated using a large language model, a burden on the user for adjustment for obtaining a document desired by the user is relatively small.

FIG. 13 is a diagram illustrating an example of a configuration of a computer according to at least one example embodiment.

In the configuration illustrated in FIG. 13, a computer 700 includes a central processing unit (CPU) 710, a main storage device 720, an auxiliary storage device 730, an interface 740, and a nonvolatile recording medium 750.

The document generation system 100 and the document generation system 200 or part thereof may be implemented in the computer 700. In this case, the operation of each processing unit described above is stored in the auxiliary storage device 730 in the form of a program. The CPU 710 reads the program from the auxiliary storage device 730, loads the program in the main storage device 720, and executes the above processing according to the program. The CPU 710 secures a storage area related to each of the above-described storage units in the main storage device 720 according to the program.

Communication between the document generation system 100 or part thereof or the document generation system 200 or part thereof and another device is executed by the interface 740 having a communication function and performing communication under the control of the CPU 710. The interaction between the document generation system 100 or part thereof or the document generation system 200 or part thereof and the user is executed by the interface 740 having an input device and an output device, presenting information to the user by the output device according to the control of the CPU 710, and receiving a user operation by the input device. The interface 740 has a port for the nonvolatile recording medium 750, and reads information from the nonvolatile recording medium 750 and writes information to the nonvolatile recording medium 750.

Any one or more of the above-described programs may be recorded in the nonvolatile recording medium 750. In this case, the interface 740 may read the program from the nonvolatile recording medium 750. The CPU 710 may directly execute the program read by the interface 740, or may temporarily store the program in the main storage device 720 or the auxiliary storage device 730 and execute the program.

The process of each unit may be performed by recording a program for executing all or part of the processing performed by the document generation system 100 and the document generation system 200 in a computer-readable recording medium, and causing a computer system to read and execute the program recorded in the recording medium. The “computer system” herein includes an operating system (OS) and hardware such as peripheral devices.

The “computer-readable recording medium” refers to a portable medium such as a flexible disk, a magneto-optical disk, a read only memory (ROM), and a compact disc read only memory (CD-ROM), and a storage device such as a hard disk built in a computer system. The program may be for implementing some of the functions described above, and the functions described above may be implemented in combination with a program already recorded in the computer system.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. Each example embodiment can be appropriately combined with other example embodiments.

Some or all of the above example embodiments may be described as the following Supplementary Notes, but are not limited to the following Supplementary Notes.

### Supplementary Note 1

A document generation system including
a document generation means for inputting, to a large language model, a template of a document and an input document that is an individual document for each document generated by the large language model to generate an output document,
a template correction means for inputting the output document, a final document that is a document obtained by a user correcting the output document, the template, and the input document to a large language model to generate a corrected template, and
a template providing means for storing a plurality of templates including the corrected template, and outputting a selected template among the plurality of stored templates to the document generation means.

### Supplementary Note 2

The document generation system according to Supplementary Note 1, wherein
the template providing means outputs a plurality of selected templates among a plurality of stored templates to the document generation means,
the document generation means generates the output document for each of the plurality of selected templates, and
the template correction means inputs, to the large language model, an output document selected by a user among a plurality of the generated output documents, a final document obtained by the user correcting the output document, a template and an input document based on which the output document is generated, and acquires a corrected template for the template.

### Supplementary Note 3

The document generation system according to Supplementary Note 2, wherein the template providing means selects a plurality of templates to be output to the document generation means based on the number of times a template has been used to generate an output document selected by a user.

### Supplementary Note 4

The document generation system according to Supplementary Note 3, wherein in a case where a certain template is used to generate an output document selected by a user, the template providing means, for each template stored in the template providing means, adds a value obtained by multiplying the number of times of use of the template by a coefficient that is 0 or more and 1 or less, the coefficient being larger as a distance between the template and a template used to generate an output document selected by the user on a tree diagram based on generation of the template is shorter.

### Supplementary Note 5

The document generation system according to any one of Supplementary Notes 2 to 4, wherein
in a case where the number of templates stored in the template providing means is greater than or equal to a predetermined number, the template correction means generates a combined template in which a plurality of selected templates among the templates stored in the template providing means is combined into one template, and
the template providing means replaces the plurality of selected templates among the templates stored in the template providing means with the combined template in which the plurality of templates is combined into the one template.

### Supplementary Note 6

The document generation system according to Supplementary Note 5, wherein the template correction means generates the combined template in which a plurality of templates selected in descending order of the number of times of use in generating an output document selected by a user among the templates stored in the template providing means is combined into one template.

### Supplementary Note 7

The document generation system according to Supplementary Note 5, wherein the template correction means generates the combined template in which a plurality of templates selected in ascending order of the number of times of use in generating an output document selected by a user among the templates stored in the template providing means is combined into one template.

### Supplementary Note 8

A document generation method executed by a computer, the method including
inputting, to a large language model, a template of a document and an input document that is an individual document for each document generated by the large language model to generate an output document,
inputting the output document, a final document that is a document obtained by a user correcting the output document, the template, and the input document to a large language model to generate a corrected template, and
storing a plurality of templates including the corrected template, and using a selected template among the plurality of stored templates in generating the output document.

### Supplementary Note 9

A program for causing a computer to execute the steps of
inputting, to a large language model, a template of a document and an input document that is an individual document for each document generated by the large language model to generate an output document,
inputting the output document, a final document that is a document obtained by a user correcting the output document, the template, and the input document to a large language model to generate a corrected template, and
storing a plurality of templates including the corrected template, and using a selected template among the plurality of stored templates in generating the output document.

The Supplementary Notes related to Supplementary Notes 2 to 7 can also be dependent on Supplementary Notes 8 and 9.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. A document generation system comprising:
one or more memories storing instructions and a plurality of document templates; and
one or more processors configured to execute the instructions to:
input, to a large language model, a template selected from the document templates and an input document generated by a user to generate an output document;
input, to a large language model, the output document, a final document that is a document obtained by a user correcting the output document, the template, and the input document to generate a corrected template; and
store the corrected template in the one or more memories.

2. The document generation system according to claim 1, wherein
the one or more processors are further configured to execute the instructions to:
select a plurality of templates from the document templates;
generate the output document for each of the plurality of selected templates; and
input, to the large language model, an output document selected by a user among the plurality of the output documents, a final document obtained by the user correcting the output document, the template and the input document based on which the output document was generated, to generate a corrected template for the template.

3. The document generation system according to claim 2, wherein the one or more processors are configured to execute the instructions to select the plurality of templates to be used for generating the output documents based on the number of times a template has been used to generate an output document selected by a user.

4. The document generation system according to claim 3, wherein the one or more processors are configured to execute the instructions to, in a case where a certain template is used to generate an output document selected by a user, for each template stored in the one or more memories, add to the number of times the template has been used to generate an output document selected by a user a value obtained by multiplying the number of times of use of the template by a coefficient that is 0 or more and 1 or less, the coefficient being larger as a distance between the template and a template used to generate an output document selected by the user on a tree diagram based on generation of the template is shorter.

5. The document generation system according to claim 2, wherein
the one or more processors are further configured to execute the instructions to:
in a case where the number of the document templates stored in the one or more memories becomes greater than or equal to a predetermined number, generate a combined template in which a plurality of selected templates among the document templates is combined into one template; and
replace the plurality of selected templates among the templates stored in the one or more memories with the combined template in which the plurality of templates is combined into the one template.

6. The document generation system according to claim 5, wherein the one or more processors are configured to execute the instructions to generate the combined template in which a plurality of templates selected in descending order of the number of times of use in generating an output document selected by a user among the document templates stored in the one or more memories is combined into one template.

7. The document generation system according to claim 5, wherein the one or more processors are configured to execute the instructions to generate the combined template in which a plurality of templates selected in ascending order of the number of times of use in generating an output document selected by a user among the document templates stored in the one or more memories is combined into one template.

8. A document generation method comprising:
by a computer having one or more memories storing a plurality of document templates,
inputting, to a large language model, a template selected from the document templates and an input document generated by a user to generate an output document;
inputting the output document, a final document that is a document obtained by a user correcting the output document, the template, and the input document to a large language model to generate a corrected template; and
storing the corrected template in the one or more memories.

9. A non-transitory recording medium recording a program for causing a computer having one or more memories storing a plurality of document templates to execute:
inputting, to a large language model, a template selected from the document templates and an input document generated by a user to generate an output document;
inputting the output document, a final document that is a document obtained by a user correcting the output document, the template, and the input document to a large language model to generate a corrected template; and
storing the corrected template in the one or more memories.
